(19) United States
(12) Patent Application Publication
(10) Pub. No.: US 2023/0273991 A1
(43) Pub. Date: Aug. 31, 2023

(54) DECENTRALIZED POLICY FOR SECURE SHARING OF A TRUSTED EXECUTION ENVIRONMENT (TEE) AMONG INDEPENDENT WORKLOADS

(71) Applicant: Intel Corporation, Santa Clara, CA (US)

(72) Inventors: Bin Xing, Hillsboro, OR (US); Daniel Middleton, Orono, MN (US)

(73) Assignee: Intel Corporation, Santa Clara, CA (US)

(21) Appl. No.: 18/311,404

(22) Filed: May 3, 2023

Related U.S. Application Data
(60) Provisional application No. 63/388,040, filed on Jul. 11, 2022.

(51) Int. Cl. G06F 21/53

(52) U.S. Cl. CPC G06F 21/53; G06F 2221/034

(57) ABSTRACT

A computing system to receive a new workload by a trusted execution environment virtual machine (TVM); validate the new workload; in response to the new workload being successfully validated, evaluate a launch policy of the new workload against one or more launch policies of one or more existing workloads of the TVM; and in response to the launch policy of the new workload being successfully validated, load the new workload into the TVM.

### CROSS-REFERENCE TO RELATED APPLICATION

This application claims the benefit of U.S. Provisional Patent Application No. 63/388,040, filed Jul. 11, 2022, which is incorporated by reference herein in its entirety.

### FIELD OF THE DISCLOSURE

This disclosure relates generally to security in computing systems, and more particularly, to secure sharing of a trusted execution environment (TEE) among independent workloads in computing systems.

### BACKGROUND

Some computing systems provide confidential computing architectures that include architectural elements to help deploy hardware-isolated, trusted execution environment (TEE) virtual machines (VMs)(TVMs). In some implementations, TVMs are called trusted domains (TDs). One example of such a confidential computing architecture is Intel® Trust Domain Extensions (Intel® TDX). TDX is designed to isolate TDs from a virtual machine manager (VMM)/hypervisor and any other non-TD software on the computing system to protect TDs from a broad range of potential software attacks.

Software containers are often used for cloud native applications. With the emergence of TEE technologies (e.g., TDX, Software Guard Extensions (SGX), Secure Encrypted Virtualization (SEV), etc.), there's a desire to run computing workloads (e.g., containers) inside TEEs to reduce attack surfaces on a trusted computing base (TCB).

Hypothetically, every workload can run in its own TVM for maximal protection. But in practice some workloads are designed to collaborate with each other, hence it is desirable to be able to run them in a single TVM for: 1) Better performance—Intra-TVM communication (among workloads) bears lower overhead than inter-TVM communication; 2) Better security—Intra-TVM communication cannot be eavesdropped or tampered by any software entities outside the TVM; and 3) Better utilization of resources, since the number of TVMs that can coexist on a physical platform is limited. Grouping workloads help reduce the total number of TVMs needed to execute the workloads.

However, running multiple independent workloads in a TVM gives rise to various security issues.

### BRIEF DESCRIPTION OF THE DRAWINGS

FIG. 1 is a block diagram illustrating an example computing system environment that provides isolation in virtualized systems using TVMs according to an implementation.

FIG. 2 illustrates a computing system for implementing secure sharing of a TVM by independent workloads according to decentralized launch policies in an implementation.

FIG. 3 illustrates a workload in an implementation.

FIG. 4 is flow diagram of processing for secure sharing of a TVM by independent workloads according to decentralized launch policies, in an implementation.

FIG. 5 is a block diagram of an example processor platform structured to execute and/or instantiate the machine-readable instructions and/or operations of FIGS. 1-4 to implement the apparatus discussed with reference to FIGS. 1-4.

FIG. 6 is a block diagram of an example implementation of the processor circuitry of FIG. 5.

FIG. 7 is a block diagram of another example implementation of the processor circuitry of FIG. 5.

FIG. 8 is a block diagram illustrating an example software distribution platform to distribute software such as the example machine readable instructions of FIG. 5 to hardware devices owned and/or operated by third parties.

The figures are not to scale. In general, the same reference numbers will be used throughout the drawing(s) and accompanying written description to refer to the same or like parts.

### DETAILED DESCRIPTION

The technology described herein provides a method, system and apparatus to manage decentralized launch policies governing secure sharing of trusted execution environment (TEE) virtual machines (VMs)(TVMs) among independent workloads. In one implementation, a workload is any program or application that runs on any computing system. In an implementation, a workload comprises a container.

Some implementations herein are described with respect to the confidential computing architecture of Intel® TDX, although other implementations may also be used in other confidential computing architectures including TVMs, such as AMD® Secure Encrypted Virtualization (SEV) or ARM® Realm Management Extension (RME), for example.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and/or other changes may be made without departing from the scope of the subject matter of this disclosure. The following detailed description is, therefore, provided to describe example implementations and not to be taken as limiting on the scope of the subject matter described in this disclosure. Certain features from different aspects of the following description may be combined to form yet new aspects of the subject matter discussed below.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real-world imperfections.

As used herein, “processor” or “processing device” or “processor circuitry” or “hardware resources” are defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s). As used herein, a device may comprise processor circuitry or hardware resources.

As used herein, a computing system can be, for example, a server, a disaggregated server, a personal computer, a workstation, a self-learning machine (e.g., a neural network), a mobile device (e.g., a cell phone, a smart phone, a tablet (such as an iPad™)), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, an electronic voting machine, or any other type of computing device.

In the following description, numerous specific details are set forth, such as specific application binary interface (ABI) primitives, specific operations and sequences of operations, specific Intel® Trust Domain Extensions (TDX) implementation details, and the like. However, embodiments may be practiced without these specific details. In other instances, well-known circuits, structures and techniques have not been shown in detail to avoid obscuring the understanding of the description. In other implementations, TDX may be known as a trusted execution environment (TEE) security manager (TSM).

Cloud security providers (CSPs), driven by their customers' requirements, desire cryptographic isolation for customer workloads running on their computing platforms. In some implementations, cryptographic isolation may be provided by Secure Memory Encryption (SME) and Secure Encrypted Virtualization (SEV) from Advanced Micro Devices, Inc. (AMD) to meet these requirements for the cloud providers. In other implementations, cryptographic isolation may be provided by TDX from Intel® Corporation for providing such isolation on servers and removing CSP software (e.g., virtual machine manager (VMM)) from the trust boundary. TDX provides cryptographic isolation for customer workloads in a cloud computing environment using a multi-key (MK) total memory encryption engine (TME)(MK-TME), which provides both confidentiality and integrity. While the cryptographic mechanisms implemented in the MKTME engine circuitry are used to provide confidentiality and integrity to trust domain data, they impose additional performance overheads.

In some implementations, protected TVMs may be TDs in TDX. TDX extends Virtual Machines Extensions (VMX) and MKTME with a virtual machine guest called a trust domain (TD). A TD runs in a central processing unit (CPU) mode which protects the confidentiality of the TD's memory contents and the TD's CPU state from any other software, including a VMM, unless explicitly shared by the TD itself. TDX is built on top of Secure Arbitration Mode (SEAM), which is a CPU mode and extension of the VMX instruction set architecture (ISA). The TDX module, running in SEAM mode, serves as an intermediary between VMM and the guest TDs. The VMM is expected to be TDX-aware. The VMM can launch and manage both guest TDs and legacy guest VMs. The VMM may maintain legacy functionality from the legacy VMs perspective. The VMM may be restricted regarding the TDs managed by the VMM.

Generally, a trusted execution environment security manager (TSM) (such as a TDX module in a TDX architecture) may help to provide confidentiality (and integrity) for customer (tenant) software executing in an untrusted CSP infrastructure. The TVM architecture, which can be a System-on-Chip (SoC) capability, provides isolation between TVM workloads and CSP software, such as a VMM of the computing system 101 managed by a CSP. Components of the TVM architecture may include 1) memory encryption (e.g., via a MKTME engine), 2) a resource management capability such as a VMM, and 3) execution state and memory isolation capabilities in a processor of platform hardware provided via a TSM managed Physical Address Metadata Table (PAMT) 116 and via TSM enforced confidential TVM control structures. The TVM architecture provides an ability of a processor to deploy TVMs that leverage a memory encryption engine (such as the MKTME engine), the PAMT, a Secure (integrity-protected) Extended Page Table (SEPT) and access-controlled confidential TVM control structures for secure operation of TVM workloads.

In one implementation, the tenant's software is executed in a TVM (e.g., a TD). This TVM (also referred to as a tenant TVM) refers to a tenant workload (which can comprise an OS alone along with other ring-3 applications running on top of the OS, or a VM running on top of VMM along with other ring-3 applications, for example). Each TVM may operate independently of other TVMs in the system and may use logical processor(s), memory, and I/O assigned by the VMM on the platform. Each TVM may be cryptographically isolated in memory using at least one exclusive encryption key of the memory encryption engine (e.g., MKTME engine) to encrypt the memory (holding code and/or data) associated with the TVM.

In some implementations, the VMM in the TVM architecture may act as a host for the TVMs and may have full control of the cores and other components of computing system 101 hardware. The VMM may assign software in a TVM with logical processor(s). The VMM, however, may be restricted from accessing the TVM's execution state on the assigned logical processor(s). Similarly, the VMM assigns physical memory and I/O resources to the TVMs but is not privy to access the memory state of a TVM due to the use of separate encryption keys enforced by the CPUs per TVM, and other integrity and replay controls on memory. Software executing in a TVM operates with reduced privileges so that the VMM can retain control of platform resources. However, the VMM cannot affect the confidentiality or integrity of the TVM state in memory or in the CPU structures under defined circumstances.

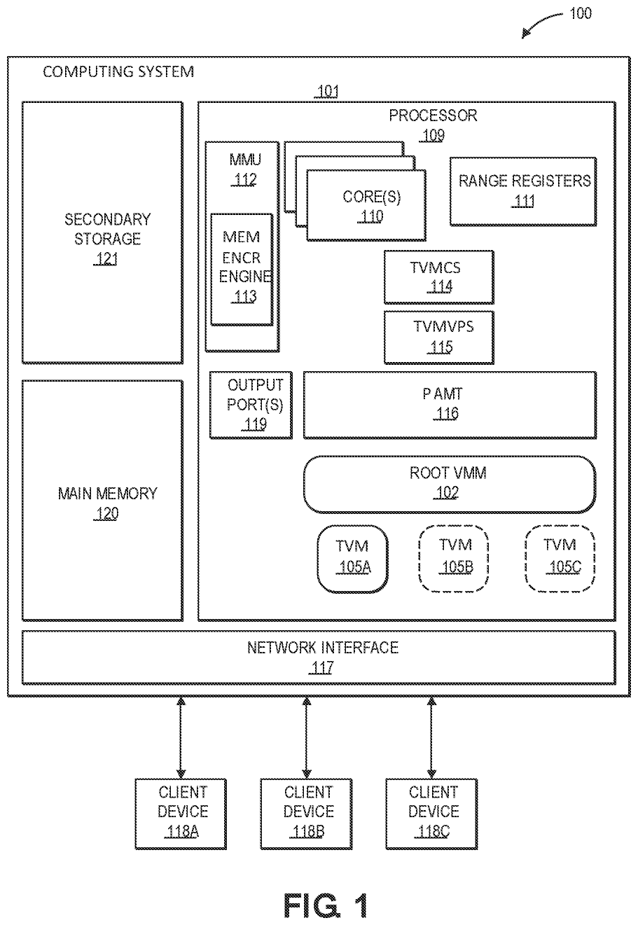

FIG. 1 is a schematic block diagram of a computing system environment 100 that provides isolation in virtualized systems using TVMs, according to an implementation of the disclosure. The computing system environment 100 supports client devices 118A-118C. Computing system 101 includes at least one processor 109 (also referred to as a processing device) that executes a root VMM 102 (which may be an implementation of a VMM). The root VMM 102 may include a VMM (which may also be referred to as hypervisor) that may instantiate one or more TVMs 105A-105C accessible by the client devices 118A-118C via a network interface 117. The client devices may include, but are not limited to, one or more of a desktop computer, a tablet computer, a laptop computer, a netbook, a notebook computer, a personal digital assistant (PDA), a server, a workstation, a cellular telephone, a mobile computing device, a smart phone, an Internet appliance or any other type of computing device.

A TVM may refer to a tenant (e.g., customer) workload. The tenant workload can include an OS alone along with ring-3 applications running on top of the OS or can include a VM running on top of a VMM along with ring-3 applications, for example.

The processor 109 may include one or more cores 110, range registers 111, a memory management unit (MMU) 112, and output port(s) 119, one or more TVM control structure(s) (TVMCS(s)) 114 and TVM virtual-processor control structure(s) (TVMVPS(s)) 115. The processor 109 may be used in a system that includes, but is not limited to, a desktop computer, a tablet computer, a laptop computer, a netbook, a notebook computer, a personal digital assistant (PDA), a server, a workstation, a cellular telephone, a mobile computing device, a smart phone, an Internet appliance or any other type of computing device. In another implementation, processor 109 may be used in a SoC system.

The computing system 101 may be a server or other computer system having one or more processors available from Intel Corporation, AMD, Inc., or other processor developer, although the scope of the technology described herein is not so limited. In one implementation, sample computing system 101 executes a version of the WINDOWS™ operating system available from Microsoft Corporation of Redmond, Wash., although other operating systems (UNIX and Linux for example), embedded software, and/or graphical user interfaces, may also be used. Thus, implementations of the disclosure are not limited to any specific combination of hardware circuitry and software.

The one or more processing cores 110 execute instructions of the system. The processing core 110 includes, but is not limited to, pre-fetch circuitry to fetch instructions, decode circuitry to decode the instructions, execution circuitry to execute instructions and the like. In an implementation, the computing system 101 includes a component, such as the processor 109 to employ execution units including circuitry to perform processes for processing data.

Computing system 101 includes a main memory 120 and a secondary storage 121 to store program binaries and OS driver events. Data in the secondary storage 121 may be stored in blocks referred to as pages, and each page may correspond to a set of physical memory addresses. The computing system may employ virtual memory management in which applications run by the core(s) 110, such as the TVMs 105A-105C, use virtual memory addresses that are mapped to guest physical memory addresses, and guest physical memory addresses are mapped to host/system physical addresses by a MMU 112.

The core 110 may use the MMU 112 to load pages from the secondary storage 121 into the main memory 120 (which includes a volatile memory and/or a non-volatile memory) for faster access by software running on the processor 109 (e.g., on the core). When one of the TVMs 105A-105C attempts to access a virtual memory address that corresponds to a physical memory address of a page loaded into the main memory, the MMU returns the requested data. The core 110 may execute the VMM portion of root VMM 102 to translate guest physical addresses to host physical addresses of main memory and provide parameters for a protocol that allows the core to read, walk and interpret these mappings.

In one implementation, processor 109 implements a TVM architecture and ISA extensions (SEAM) for the TVM architecture. The SEAM architecture and the trusted execution environment security manager (TSM) running in SEAM mode to provide isolation between TVM workloads 105A-105C and from CSP software (e.g., a CSP VMM (e.g., root VMM 102)) executing on the processor 109). Components of the TVM architecture can include 1) memory encryption, integrity and replay-protection via a memory encryption engine 113; 2) a resource management capability referred to herein as the root VMM 102; and 3) execution state and memory isolation capabilities in the processor 109 provided via a PAMT 116 and via access-controlled confidential TVM control structures (e.g., TVMCS 114 and TVMVPS 115). The TVM architecture provides an ability of the processor 109 to deploy TVMs 105A-105C that leverage the memory encryption (mem encr) engine 113, the PAMT 116, and the access-controlled TVM control structures (e.g., TVMCS 114 and TVMVPS 115) for secure operation of TVM workloads 105A-105C.

In implementations of the disclosure, the root VMM 102 acts as a host and has control of the cores 110 and other platform hardware. A VMM assigns software in a TVM 105A-105C with logical processor(s). The VMM, however, cannot access a TVM's execution state on the assigned logical processor(s). Similarly, a VMM assigns physical memory and I/O resources to the TVMs but is not privy to access the memory state of the TVMs due to separate encryption keys, and other integrity and replay controls on memory.

With respect to the separate encryption keys, the processor may utilize the memory encryption engine 113 to encrypt (and decrypt) memory used during execution. With total memory encryption (TME), any memory accesses by software executing on the core 110 can be encrypted in memory with an encryption key. In an implementation, MKTME is an enhancement to TME that allows use of multiple encryption keys that may be implemented in memory encryption engine 113. The processor 109 may utilize the memory encryption engine to cause different pages to be encrypted using different keys. The memory encryption engine 113 may be utilized in the TVM architecture described herein to support one or more encryption keys per each TVM 105A-105C to help achieve the cryptographic isolation between different CSP customer workloads. For example, when a memory encryption engine is used in the TVM architecture, the CPU enforces by default that TVM (all pages) are to be encrypted using a TVM-specific key. Furthermore, a TVM may further choose specific TVM pages to be plain text or encrypted using different ephemeral keys that are opaque to CSP software.

Each TVM 105A-105C is a software environment that supports a software stack (e.g., using virtual machine extensions (VMX)), OSes, and/or application software (hosted by the OS). Each TVM may operate largely independently of other TVMs and use logical processor(s), memory, and I/O assigned by the VMM 102 on the platform. Software executing in a TVM operates with reduced privileges so that the VMM can retain control of platform resources; however, the VMM cannot affect the confidentiality or integrity of the TVM under defined circumstances.

Computing system 101 includes a main memory 120. Main memory includes a DRAM device, a static random-access memory (SRAM) device, flash memory device, or other memory device. Main memory stores instructions and/or data represented by data signals that are to be executed by the processor 109. The processor may be coupled to the main memory via a processing device bus. A system logic chip, such as a memory controller hub (MCH) may be coupled to the processing device bus and main memory. An MCH can provide a high bandwidth memory path to main memory for instruction and data storage and for storage of graphics commands, data and textures. The MCH can be used to direct data signals between the processor, main memory, and other components in the system and to bridge the data signals between processing device bus, memory, and system I/O, for example. The MCH may be coupled to memory through a memory interface. In some implementations, the system logic chip can provide a graphics port for coupling to a graphics controller through an Accelerated Graphics Port (AGP) interconnect.

Computing system 101 may also include an I/O controller hub (ICH). The ICH can provide direct connections to some I/O devices via a local I/O bus. The local I/O bus is a high-speed I/O bus for connecting peripherals to the memory 120, chipset, and processor 109. Some examples are the audio controller, firmware hub (flash BIOS), wireless transceiver, data storage, legacy I/O controller containing user input and keyboard interfaces, a serial expansion port such as Universal Serial Bus (USB), and a network controller. The data storage device can comprise a hard disk drive, a floppy disk drive, a CD-ROM device, a flash memory device, or other mass storage device.

One aspect of TDX (or any TEE) is the capability for attestation. In the case of a TVM containing multiple workloads, such as containers, there arises the question of how to appraise the security of any individual workload, which depends not only on the workload itself but also on all other workloads running in the same TVM (plus any common code shared among them, such as the code responsible for loading workloads). Given more workloads may be loaded into the TVM over time, all other workloads fall into two categories: 1) current workloads running in the TVM at the time of attestation and 2) future workloads that will be loaded into that same TVM. Future workloads cannot be attested to so in practice it is the restrictions and criteria (e.g., that narrow down what workloads could be loaded in future) that will be attested to instead. These restrictions/criteria are referred to herein as a launch policy.

In an implementation, the launch policy is decentralized, meaning that each workload has its own launch policy. An example of a centralized policy would be having the launch policies exist only in a server. In this scenario, each TVM would need to contact the server to check for a policy. In contrast, as disclosed herein, the workload includes its own launch policy. This provides at least several advantages, such as better scaling (e.g., no contention for a single server), explicit identification (e.g., no confusing mapping of an application/workload to a launch policy stored in another location), and better security (e.g., the workload author has bound the launch policy by signature to the workload, so there is no chance of an adversary changing the launch policy on the centralized server).

To support the scenario of a TVM shared by multiple workloads that may be loaded/launched at different points in time, a secure approach is needed that must be able to the fulfill the following four requirements: 1) attest to the initial state of a TVM; 2) measure each workload before loading the workload into the TVM; 3) attest to the measurements of all workloads loaded/running in the TVM; and 4) enforce and attest to the launch policies that governs what other workloads could be loaded into the TVM in future. As used herein, a container is an example of a specific packaging format for transmitting an application in a workload, but in various implementations workloads may be any code that has one entry point that implies a single process, but that process can fork more processes/applications. Thus, a workload may be a collection of processes and their configurations.

One existing approach is informally known as a Kata Confidential Container (Kata CC), part of a confidential containers project by the Cloud Native Computing Foundation. Kata CC is the only known approach that tackles the problem of multiple containers in a TVM, such as a TD. Kata CC focuses, however, on the compatibility (rather than security) with existing Open Container Initiative (OCI) specifications, which were optimized for deployment but not for security. All container images must be encrypted to benefit from Kata CC. The encryption keys are distributed by a trusted Key Broker Service (KBS). Kata CC may launch an encrypted container image. Kata CC creates a TD with a Linux® kernel and an Initial RAM disk (initrd) that contains the kata-agent, which will be executed after the Linux® kernel boots within the TD. The kata-agent attests to KB to the initial state of the TD and receives in return the key for decrypting the container image. The container image is decrypted and launched in the container's isolated/dedicated Linux® namespaces. The attestation and decryption/launch steps can be repeated as many times as necessary to load/launch multiple containers in the same TD.

One problem of Kata CC is the lack of attestation to the identities of containers. This could lead to several security vulnerabilities. In the attestation step, the kata-agent attests to the TD's initial state only. Given the same kernel and initrd, all TDs share the same measurement. That is, all TDs created by Kata CC are indistinguishable from an attestation perspective, hence it's infeasible for the KB to restrict any TD's access to any keys. Thus, a compromised TD would be allowed to request decryption keys for arbitrary container images. In the worst case, there could be a total loss of all keys.

In the decryption/launch step, the container image is not measured, hence it's not possible to be attested to. This forces every container image to bear secrets for attestation to the container's identity (and is also the reason that every image must be encrypted to benefit from Kata CC). In the case of a container image having multiple running instances, any instance being compromised may lead to all instances being compromised. For example, a web server image may have multiple instances running and sharing the same transport layer security (TLS) certificate. An adversary that has managed to compromise one instance (and gain access to the private key) will then be able to eavesdrop/tamper traffics to/from all other instances.

The kata-agent does not restrict any containers from being loaded into the TD. Therefore, protections provided by TDX can be circumvented easily by wrapping adversarial code into an encrypted container image to be loaded via the kata-agent's public interface, and that makes the two attacks described above easier.

Since Kata CC aims at full compatibility with OCI specs, Kata CC supports all OCI runtime commands. One notable command is Exec, which starts a new process inside an existing container with a command line supplied by the (untrusted) host. This enlarges the attack surface, diminishing the security of the computing system.

In summary, Kata CC is deficient in providing adequate security.

As described above, an implementation described herein uses TDX as a specific example. However, other embodiments may be applied to any of the TEE technologies (provided necessary features, such as run-time measurement registers (RTMRs), are supported/available). The implementations described herein satisfy the four requirements stated above. The first requirement is satisfied because a measurement register trust domain (MRTD) (e.g., of TDREPORT in TDX) stores the measurement of the initial state. The second and third requirements can be satisfied using RTMRs (e.g., of TDREPORT in TDX), provided all workloads have a well-defined format. In implementations described herein, the fourth requirement is also satisfied, which also affects the design of the workload format used to satisfy the second and third requirements.

An implementation includes a decentralized launch policy defined on a per-workload basis, and a workload file format that binds the workload code/data with its launch policy and other attributes, which will serve as input for launch policy evaluation. The launch policy may be evaluated against a workload (by using the workload's attributes as input), and the outcome may be one of accept, reject, or not reject. To successfully load a new workload into a TVM with one or more existing workloads, the following two conditions must be met. The new workload's launch policy will be evaluated against every existing workload and must not reject (i.e., either accept or not reject) any of them. Every existing workload's launch policy will be evaluated against the new workload, and the launch policy must be either accepted by any one workload or not rejected by all workloads. Details on workload format definition, measurement, attestation, and policy evaluation are shown below.

Embodiments maximize the benefits of TVMs by closing security gaps left in previous existing solutions (e.g., Kata CC). An advantage includes the decentralized aspect of the launch policy (e.g., each workload has its own launch policy), which allows independent software vendors (ISVs) to provide a launch policy along with their code to improve the security of the computing system and eases integration of a plurality of workloads from a plurality of independent ISVs.

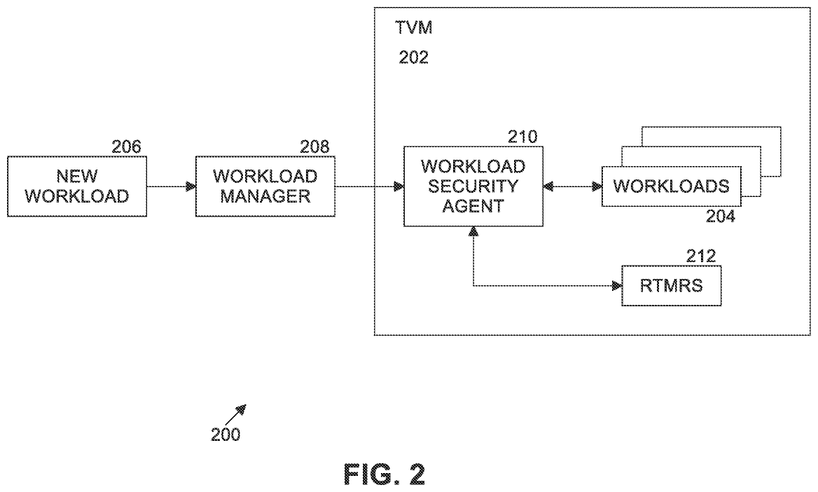

FIG. 2 illustrates a computing system 200 for implementing secure sharing of a TVM 202 by independent workloads according to decentralized launch policies in an implementation. FIG. 2 shows a process for loading a new workload 206 into TVM 202 with one or more existing workloads 204 running in the TVM. A new workload 206 arrives at a workload manager 208. The workload manager 208 is the software component responsible for creating TVMs (if necessary) and passing workloads into the TVMs. In an implementation, workload manager 208 may be implemented in root VMM 102, an operating system (OS), or a standalone software component in computing system 101. Workload manager 208 selects a TVM 202 and passes the new workload 206 into the TVM. Workload security agent 210 inside the TVM 202 receives the new workload 206, verifies the new workload (how to verify a workload depends on the workload format, which will be described below), and verifies mutual acceptance by evaluating launch policies of both the new workload 206 and zero or more existing workloads 204. The new workload 206 is measured by the workload security agent 210. How to measure depends on the workload format, which will be described below. One or more workload measurements may be stored in one or more RTMRs 212 in processor 109. The new workload 206 is then launched (e.g., in an implementation, a workload may be an application that runs in the guest kernel inside the TVM).

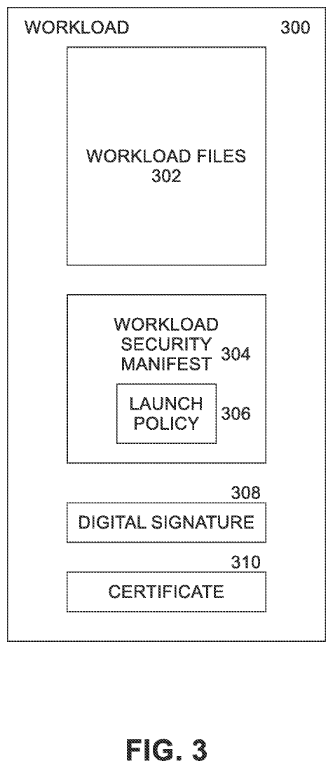

FIG. 3 illustrates a workload 300 in an implementation. As used herein, a workload (such as zero or more workloads 204 and new workload 206) includes: 1) workload files 302, which may include a collection of directories and/or files from which a task may be created and run inside a TVM; 2) a workload security manifest 304, which may include references in the form of hash values to the workload files 302, along with one or more workload attributes. An attribute of workload security manifest 304 is launch policy 306; 3) a digital signature 308 computed over the workload manifest; and 4) a digital certificate 310 for verifying the digital signature 308.

As used herein, a launch policy includes a list of identities and rules. The identities are of other workloads that are annotated to convey they are trusted or distrusted by this workload. An identity may be in the form of a cryptographic hash value or a public key. In the case of the latter, the public key may identify a trusted provider of a workload rather than a specific instance of a workload. The launch policy also includes rules, such as an indication of what to do in the case of workload identities that are not explicitly listed, e.g., reject all workloads with identities not explicitly allowed here. Launch policies are described further below.

In an implementation, to facilitate transportation and measurement, the workload files 302 may be packaged into a single archive format, such as a “tar ball”. In this case the workload security manifest 304 references only one archive blob (rather than individual files). The workload security manifest 304 may be represented as a set of key/value pairs, which may be stored, for example, in a JavaScript Object Notation (JSON file) as shown in the example of Table 1.

```
TABLE 1
$ cat workload.json
{
  “payload”: “sha1:1d6edd6d65a3ddecf1e66d120a0cad65ac7599ad”,
  “product_name”: “Some Workload”,
  “svn”: 2,
  “policy”: {
    “accepts”: [
      {
        “signer”: “sha1:ca2f21fdd41eea7a6c9eca255d65786019aa8e10”,
        “product_name”: “Another Workload”,
        “svn_min”: 1
      },
      {
        “workload”: “sha1:44ab18alf72bc462870a09951a9d68b9782cfc96”,
      }
    ],
    “OPA_policy”: “sha1:1bfdf1a092845cc16b1f6a0f5dcbf1eb0db42683”,
    “reject_unless_accepted”: false
  }
}
```

The “product_name” and “svn” fields describe attributes serving as inputs for launch policies evaluated by other workloads. The “policy” object encodes this workload's launch policy. A launch policy accepts workloads that match any of the entries in the “accepts” array. Two examples are shown above, one matches “signer”, “product_name” and “svn_min”; while the other matches the hash of the workload manifest directly. Besides matching attributes directly, an implementation may delegate decision making to external programs/tools/entities. An Open Policy Agent (OPA) policy, as described by the Open Policy Agent (a policy-based control for cloud-native environments disclosed on the Internet at openpolicyagent.org), here serves as an example. A “reject” is a Boolean value that specifies the default outcomes for workloads not matching any of the above. If true, unmatched workloads will be rejected, otherwise will not be rejected.

In an implementation, the whole JSON file is signed. Workload security agent 210 verifies the digital signature 308, then considers the hash of the signing certificate 310 as the identity of the workload vendor (e.g., the ISV that produced the workload code), which is matched against “signer” in the “policy”.

As described above, the outcome from an evaluation of a launch policy could be one of accepted, rejected, or not rejected. To determine if a new workload 206 can be loaded into a TVM 202, the workload security agent 210 evaluates the new workload's launch policy against all existing workloads 204. The new workload 206 must not reject (i.e., either accept or not reject) any existing workloads, or the new workload will be rejected. The workload security agent 210 also evaluates policies of all existing workloads 204 against the new workload 206. The new workload 206 must either be accepted by at least one existing workload or not rejected by all existing workloads.

Now that the workload format and the launch policy are defined, workloads may be measured in various ways. In an example, the hash of the workload security manifest 304 covers all the workload's attributes including the payload (e.g., workload files 302) and launch policy 306, so the hash is cryptographically bound to the behavior of the workload, and hence can serve as the workload's identity. A digital signature 308 can then be created on the workload's hash, serving as an endorsement by the signer. In practice, both should be measured and extended to a RTMR, and serve as evidence in attestation. In various implementations, measurements may use only the workload's hash, only the workload's digital signature, or the combination of both the workload hash and signature, as the workload's identity.

In an implementation, when the TVM is a TD, a TDREPORT/quote may be generated when requested. In an embodiment, the TDREPORT contains a measurements report of the TD (MRTD), which attests to the initial state of the TD (when the TVM is a TD), and RTMRs (which attest to a list of identities of running workloads, and the order in which they were loaded into the TD). Each workload's identity attests to the launch policy accompanying the workload. All launch policies are attested to by RTMRs as well. By verifying the launch policies, a relying party is assured only workloads compatible with the aggregation of those launch policies can be loaded in future.

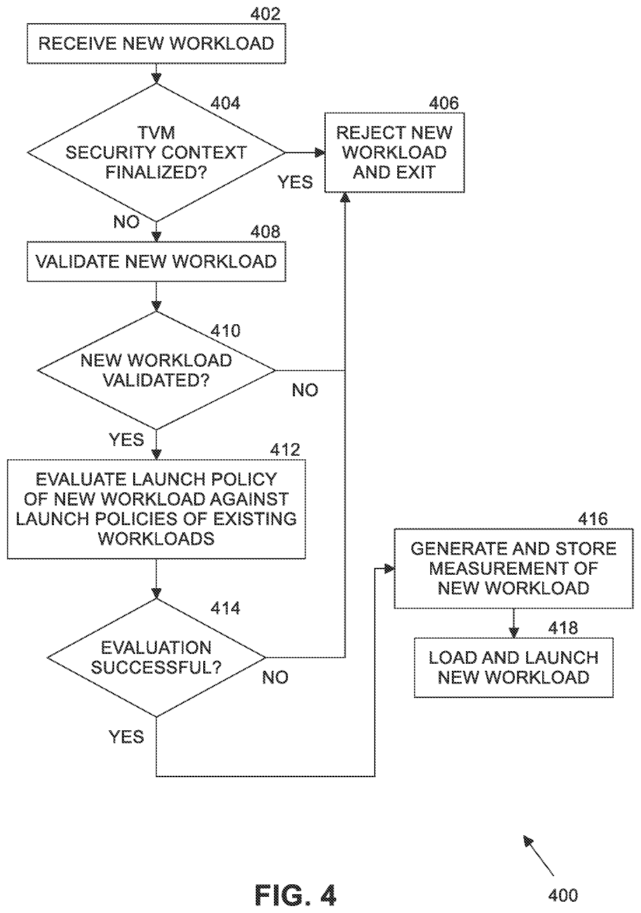

FIG. 4 is flow diagram of processing 400 for secure sharing of a TVM by independent workloads according to decentralized launch policies, in an implementation. At block 402, workload security agent 210 receives a new workload 206. In an implementation, the new workload is received as part of a call from the workload manager 208 to the workload security agent 210 in the TVM 202. At block 404, if the security context of the TVM 202 is finalized, then the new workload 206 is rejected and the call to the workload security agent is exited at block 406. As used herein, a TVM being finalized means that the TVM 202 is now running all allowed processes/applications of workloads that are part of a security context. The workload security agent 210 enforces this condition by refusing to accept any more workloads for the TVM.

If the TVM is not finalized, at block 408 workload security agent 210 validates the new workload 206. In an implementation, validation includes verification of the new workload's certificate 310. In another implementation, validation includes verification of the new workload's digital signature 308. If the validation fails, then the new workload 206 is rejected and the call to the workload security agent is exited at block 406. If validation of the new workload is successful, then at block 412 workload security agent 210 evaluates the launch policy 306 of the workload security manifest 304 of the new workload 206 against the launch policies of existing workloads of the TVM 202. In an implementation, this evaluation is bilateral. That is, the requirements of the launch policy of the new workload are evaluated against the launch policies of the existing workloads and the requirements of the launch policies of the existing workloads are evaluated against the launch policy of the new workload. If these evaluations are successful, then at block 416 the workload security agent generates a measurement of the new workload and stores the measurement in one or more registers in processor 101, such as RTMRs 212.

The workload security agent hashes the workload contents and extends the RTMR with that measurement. When an external system wants to interact with the TVM, the external system will request an attestation to decide whether to trust the TVM. That attestation will include all of the workload measurements up to that point in time. Typically, that would happen after the TVM has been finalized.

At block 418, the new workload 206 is loaded and launched in the TVM 202 (e.g., loaded and run in the TVM by executing instructions in the workload files 302 of the new workload 206 by the processor), if requested by workload manager 208. In an implementation, the new workload may be loaded but not launched by the actions of the workload security agent shown in FIG. 4.

Workload security agent 210 may reject the new workload, for example, in response to the TVM being finalized, the TVM having insufficient computing resources available to run the new workload, the new workload was not validated, or the launch policy of the new workload was not successfully validated.

In an implementation, a launch policy 306 comprises a whitelist of accepted workloads that are compatible with each other. In this case, a new workload is rejected unless explicitly accepted. The specific steps of evaluation of launch policies may be implementation-specific, and may include one or more, in any combination, of evaluating a digital certificate 310, evaluating a hash of workload security manifest 304, product name and version, or other identifying information about the new workload.

A new workload may collaborate with or depend on other workloads, hence the new workload's list of accepted workloads in the new workload's launch policy may not be exhaustive. In an implementation, the new workload's launch policy may include a “reject_unless_accepted” status for a workload to allow the launch policy to be assertive. For example, if a “reject_unless_accepted) status is set to true, all workloads must be accepted directly (listed in an “accepts” list) or indirectly (listed in an “accepts” list of those workloads that have been accepted either directly or indirectly) by this workload's policy. Alternatively, if a “reject_unless_accepted” status is set to false, the decision to accept or reject other existing workloads for those workloads not listed in the new workload's list of accepted workloads may be made by other assertive workloads (which could have been loaded already or would be loaded in future).

In an implementation, a new workload may be tagged as accepted, rejected, or rejecting. When the new workload is accepted, the new workload is listed in at least one existing workload's list of accepted workloads or there is no existing workloads with a “reject_unless_accepted” status set to true. When the new workload is rejected, evaluation of the new workload's launch policy as compared to the launch policies of the existing workloads was unsuccessful. When the new workload is rejecting, the new workload can be accepted and has the new workload's “reject_unless_accepted” status set to true (resulting in rejecting other workloads that the new workload does not accept directly or indirectly).

While an example manner of implementing the technology described herein is illustrated in FIGS. 1-4, one or more of the elements, processes, and/or devices illustrated in FIGS. 1-4 may be combined, divided, re-arranged, omitted, eliminated, and/or implemented in any other way. Further, the example improved computing system 101 may be implemented by hardware, software, firmware, and/or any combination of hardware, software, and/or firmware. Thus, for example, any portion or all of the improved computing system 101 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example hardware resources is/are hereby expressly defined to include a non-transitory computer readable storage device or storage disk such as a memory, a digital versatile disk (DVD), a compact disk (CD), a Blu-ray disk, etc., including the software and/or firmware. Further still, the example embodiments of FIGS. 1-4 may include one or more elements, processes, and/or devices in addition to, or instead of, those illustrated in FIGS. 1-4, and/or may include more than one of any or all the illustrated elements, processes and devices.

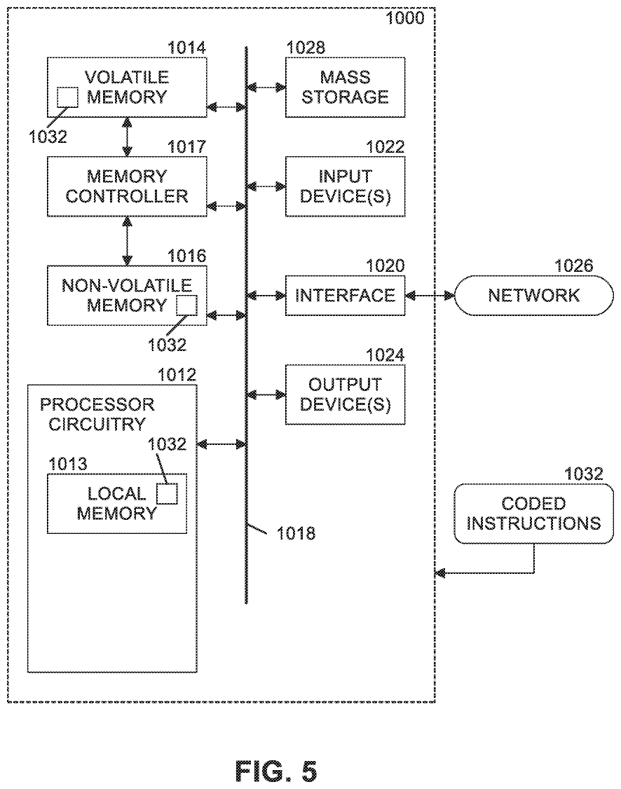

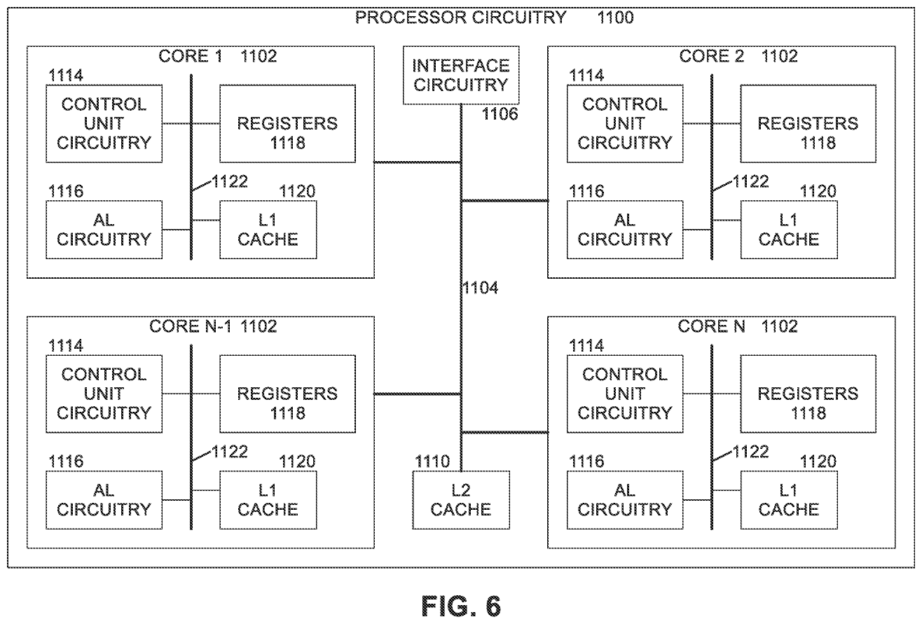

A flowchart representative of example hardware logic circuitry, machine readable instructions, hardware implemented state machines, and/or any combination thereof is shown in FIG. 4. The machine readable instructions may be one or more executable programs or portion(s) of an executable program for execution by processor circuitry, such as the processor circuitry 1012 shown in the example processor platform 1000 discussed below in connection with FIG. 5 and/or the example processor circuitry discussed below in connection with FIGS. 6 and/or 7. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The tangible machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 4, many other methods of implementing the example computing system may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable media, as used herein, may include machine readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 4 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a block diagram of an example processor platform 1000 structured to execute and/or instantiate the machine-readable instructions and/or operations of FIGS. 1-4. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements the example processor circuitry 122.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1032, which may be implemented by the machine-readable instructions of FIGS. 1-4, may be stored in the mass storage device 1028, in the volatile memory 1014, in the non-volatile memory 1016, and/or on a removable non-transitory computer readable storage medium such as a CD or DVD.

FIG. 6 is a block diagram of an example implementation of the processor circuitry 1012 of FIG. 5. In this example, the processor circuitry 1012 of FIG. 6 is implemented by a microprocessor 1100. For example, the microprocessor 1100 may implement multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all the machine-readable instructions and/or operations represented by the flowchart of FIG. 4.

The cores 1102 may communicate by an example bus 1104. In some examples, the bus 1104 may implement a communication bus to effectuate communication associated with one(s) of the cores 1102. For example, the bus 1104 may implement at least one of an Inter-Integrated Circuit (I2C) bus, a Serial Peripheral Interface (SPI) bus, a PCI bus, or a PCIe bus. Additionally or alternatively, the bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2_cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the L1 cache in local memory 1120, and an example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating point operations. In yet other examples, the AL circuitry 1116 may include first AL circuitry that performs integer-based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 6. Alternatively, the registers 1118 may be organized in any other arrangement, format, or structure including distributed throughout the core 1102 to shorten access time. The bus 1104 may implement at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general-purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

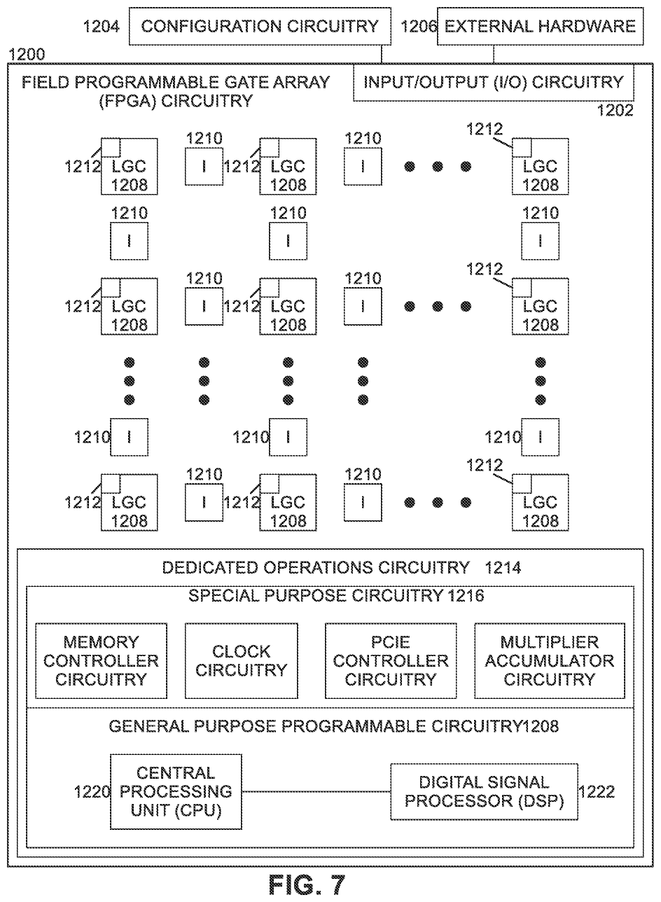

FIG. 7 is a block diagram of another example implementation of the processor circuitry 1012 of FIG. 5. In this example, the processor circuitry 1012 is implemented by FPGA circuitry 1200. The FPGA circuitry 1200 can be used, for example, to perform operations that could otherwise be performed by the example microprocessor 1100 of FIG. 6 executing corresponding machine-readable instructions. However, once configured, the FPGA circuitry 1200 instantiates the machine-readable instructions in hardware and, thus, can often execute the operations faster than they could be performed by a general-purpose microprocessor executing the corresponding software.

More specifically, in contrast to the microprocessor 1100 of FIG. 6 described above (which is a general purpose device that may be programmed to execute some or all of the machine readable instructions represented by the flowchart of FIG. 4 but whose interconnections and logic circuitry are fixed once fabricated), the FPGA circuitry 1200 of the example of FIG. 7 includes interconnections and logic circuitry that may be configured and/or interconnected in different ways after fabrication to instantiate, for example, some or all of the machine readable instructions represented by the flowchart of FIG. 4. In particular, the FPGA 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowchart of FIG. 4. As such, the FPGA circuitry 1200 may be structured to effectively instantiate some or all the machine-readable instructions of the flowchart of FIG. 4 as dedicated logic circuits to perform the operations corresponding to those software instructions in a dedicated manner analogous to an ASIC. Therefore, the FPGA circuitry 1200 may perform the operations corresponding to the some or all the machine-readable instructions of FIG. 4 faster than the general-purpose microprocessor can execute the same.

In the example of FIG. 7, the FPGA circuitry 1200 is structured to be programmed (and/or reprogrammed one or more times) by an end user by a hardware description language (HDL) such as Verilog. The FPGA circuitry 1200 of FIG. 7, includes example input/output (I/O) circuitry 1202 to obtain and/or output data to/from example configuration circuitry 1204 and/or external hardware (e.g., external hardware circuitry) 1206. For example, the configuration circuitry 1204 may implement interface circuitry that may obtain machine readable instructions to configure the FPGA circuitry 1200, or portion(s) thereof. In some such examples, the configuration circuitry 1204 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may implement the microprocessor 1100 of FIG. 6. The FPGA circuitry 1200 also includes an array of example logic gate circuitry 1208, a plurality of example configurable interconnections 1210, and example storage circuitry 1212. The logic gate circuitry 1208 and interconnections 1210 are configurable to instantiate one or more operations that may correspond to at least some of the machine-readable instructions of FIG. 4 and/or other desired operations. The logic gate circuitry 1208 shown in FIG. 7 is fabricated in groups or blocks. Each block includes semiconductor-based electrical structures that may be configured into logic circuits. In some examples, the electrical structures include logic gates (e.g., AND gates, OR gates, NOR gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 7 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 6 and 7 illustrate two example implementations of the processor circuitry 1012 of FIG. 5, many other approaches are contemplated. For example, as mentioned above, modern FPGA circuitry may include an on-board CPU, such as one or more of the example CPU 1220 of FIG. 7. Therefore, the processor circuitry 1012 of FIG. 5 may additionally be implemented by combining the example microprocessor 1100 of FIG. 6 and the example FPGA circuitry 1200 of FIG. 7. In some such hybrid examples, a first portion of the machine-readable instructions represented by the flowchart of FIG. 4 may be executed by one or more of the cores 1102 of FIG. 6 and a second portion of the machine-readable instructions represented by the flowchart of FIG. 4 may be executed by the FPGA circuitry 1200 of FIG. 7.

In some examples, the processor circuitry 1012 of FIG. 5 may be in one or more packages. For example, the microprocessor 1100 of FIG. 6 and/or the FPGA circuitry 1200 of FIG. 7 may be in one or more packages. In some examples, an XPU may be implemented by the processor circuitry 1012 of FIG. 5, which may be in one or more packages. For example, the XPU may include a CPU in one package, a DSP in another package, a GPU in yet another package, and an FPGA in still yet another package.

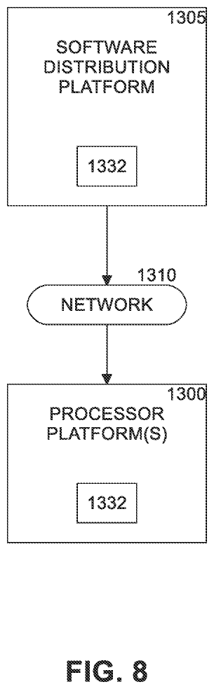

A block diagram illustrating an example software distribution platform 1305 to distribute software such as the example machine readable instructions 1032 of FIG. 5 to hardware devices owned and/or operated by third parties is illustrated in FIG. 8. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 5. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1032, which may correspond to the example machine readable instructions, as described above. The one or more servers of the example software distribution platform 1305 are in communication with a network 1310, which may correspond to any one or more of the Internet and/or any of the example networks, etc., described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1032 from the software distribution platform 1305. For example, the software, which may correspond to the example machine readable instructions described above, may be downloaded to the example processor platform 1300, which is to execute the machine-readable instructions 1032 to implement the methods described above and associated computing system 101. In some examples, one or more servers of the software distribution platform 1305 periodically offer, transmit, and/or force updates to the software (e.g., the example machine readable instructions 1032 of FIG. 5) to ensure improvements, patches, updates, etc., are distributed and applied to the software at the end user devices.

In some examples, an apparatus includes means for data processing of FIGS. 1-4. For example, the means for processing may be implemented by processor circuitry, processor circuitry, firmware circuitry, etc. In some examples, the processor circuitry may be implemented by machine executable instructions executed by processor circuitry, which may be implemented by the example processor circuitry 1012 of FIG. 5, the example microprocessor 1100 of FIG. 6, and/or the example Field Programmable Gate Array (FPGA) circuitry 1200 of FIG. 7. In other examples, the processor circuitry is implemented by other hardware logic circuitry, hardware implemented state machines, and/or any other combination of hardware, software, and/or firmware. For example, the processor circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

From the foregoing, it will be appreciated that example systems, methods, apparatus, and articles of manufacture have been disclosed that provide improved performance for security in a computing system. The disclosed systems, methods, apparatus, and articles of manufacture improve the performance of implementing security in a computing system. The disclosed systems, methods, apparatus, and articles of manufacture are accordingly directed to one or more improvement(s) in the operation of a machine such as a computer or other electronic and/or mechanical device.

The following examples pertain to further embodiments. Specifics in the examples may be used anywhere in one or more embodiments. Example 1 is a computing system including memory circuitry to store a new workload and instructions; and a processor coupled to the memory circuitry to execute the instructions to receive the new workload by a trusted execution environment virtual machine (TVM); validate the new workload; in response to the new workload being successfully validated, evaluate a launch policy of the new workload against one or more launch policies of one or more existing workloads of the TVM; and in response to the launch policy of the new workload being successfully validated, load the new workload into the TVM.

In Example 2, the subject matter of Example 1 optionally includes the processor to launch the new workload in the TVM in response to loading the new workload into the TVM. In Example 3, the subject matter of Example 1 optionally includes the processor to generate and store a measurement of the new workload in response to the launch policy of the new workload being successfully validated. In Example 4, the subject matter of Example 1 optionally includes the processor to reject the new workload in response to a security context of the TVM being finalized. In Example 5, the subject matter of Example 1 optionally includes the processor to reject the new workload in response to the TVM having insufficient computing resources available to run the new workload, the new workload not being validated, or the launch policy of the new workload not being successfully validated. In Example 6, the subject matter of Example 1 optionally wherein evaluating the launch policy of the new workload against launch policies of one or more existing workloads of the TVM comprises evaluating requirements of the launch policy of the new workload against the launch policies of the one or more existing workloads and evaluating the requirements of the launch policies of the one or more existing workloads are evaluated against the launch policy of the new workload. In Example 7, the subject matter of Example 1 optionally includes wherein the launch policy of the new workload comprises a list of compatible workloads.

Example 8 is a method including receiving a new workload by a trusted execution environment virtual machine (TVM); validating the new workload; in response to the new workload being successfully validated, evaluating a launch policy of the new workload against one or more launch policies of one or more existing workloads of the TVM; and in response to the launch policy of the new workload being successfully validated, loading the new workload into the TVM.

In Example 9, the subject matter of Example 8 optionally includes launching the new workload in the TVM in response to loading the new workload into the TVM. In Example 10, the subject matter of Example 8 optionally includes generating and storing a measurement of the new workload in response to the launch policy of the new workload being successfully validated. In Example 11, the subject matter of Example 8 optionally includes rejecting the new workload in response to a security context of the TVM being finalized. In Example 12, the subject matter of Example 8 optionally includes rejecting the new workload in response to the TVM having insufficient computing resources available to run the new workload, the new workload not being validated, or the launch policy of the new workload not being successfully validated. In Example 13, the subject matter of Example 8 optionally includes wherein evaluating the launch policy of the new workload against launch policies of one or more existing workloads of the TVM comprises evaluating requirements of the launch policy of the new workload against the launch policies of the one or more existing workloads and evaluating the requirements of the launch policies of the one or more existing workloads are evaluated against the launch policy of the new workload. In Example 14, the subject matter of Example 8 optionally includes wherein the launch policy of the new workload comprises a list of compatible workloads.

Example 15 is at least one machine-readable storage medium comprising instructions which, when executed by at least one processor, cause the at least one processor to receive a new workload by a trusted execution environment virtual machine (TVM); validate the new workload; in response to the new workload being successfully validated, evaluate a launch policy of the new workload against one or more launch policies of one or more existing workloads of the TVM; and in response to the launch policy of the new workload being successfully validated, load the new workload into the TVM.

In Example 16, the subject matter of Example 15 optionally includes instructions which, when executed by at least one processor, cause the at least one processor to launch the new workload in the TVM in response to loading the new workload into the TVM.

In Example 17, the subject matter of Example 15 optionally includes instructions which, when executed by at least one processor, cause the at least one processor to generate and store a measurement of the new workload in response to the launch policy of the new workload being successfully validated. In Example 18, the subject matter of Example 15 optionally includes instructions which, when executed by at least one processor, cause the at least one processor to reject the new workload in response to a security context of the TVM being finalized. In Example 19, the subject matter of Example 15 optionally includes wherein evaluating the launch policy of the new workload against launch policies of one or more existing workloads of the TVM comprises instructions which, when executed by at least one processor, cause the at least one processor to evaluate requirements of the launch policy of the new workload against the launch policies of the one or more existing workloads and evaluate the requirements of the launch policies of the one or more existing workloads are evaluated against the launch policy of the new workload. In Example 20, the subject matter of Example 15 optionally includes wherein the launch policy of the new workload comprises a list of compatible workloads.

Example 21 is an apparatus operative to perform the method of any one of Examples 8 to 14. Example 22 is an apparatus that includes means for performing the method of any one of Examples 8 to 14. Example 23 is an apparatus that includes any combination of modules and/or units and/or logic and/or circuitry and/or means operative to perform the method of any one of Examples 8 to 14. Example 24 is an optionally non-transitory and/or tangible machine-readable medium, which optionally stores or otherwise provides instructions that if and/or when executed by a computer system or other machine are operative to cause the machine to perform the method of any one of Examples 8 to 14.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the examples of this patent.

What is claimed is:

1. A computing system comprising:
memory circuitry to store a new workload and instructions; and
a processor coupled to the memory circuitry to execute the instructions to:
receive the new workload by a trusted execution environment virtual machine (TVM);
validate the new workload;
in response to the new workload being successfully validated, evaluate a launch policy of the new workload against one or more launch policies of one or more existing workloads of the TVM; and
in response to the launch policy of the new workload being successfully validated, load the new workload into the TVM.

2. The computing system of claim 1, comprising the processor to launch the new workload in the TVM in response to loading the new workload into the TVM.

3. The computing system of claim 1, comprising the processor to generate and store a measurement of the new workload in response to the launch policy of the new workload being successfully validated.

4. The computing system of claim 1, comprising the processor to reject the new workload in response to a security context of the TVM being finalized.

5. The computing system of claim 1, comprising the processor to reject the new workload in response to the TVM having insufficient computing resources available to run the new workload, the new workload not being validated, or the launch policy of the new workload not being successfully validated.

6. The computing system of claim 1, wherein evaluating the launch policy of the new workload against launch policies of one or more existing workloads of the TVM comprises evaluating requirements of the launch policy of the new workload against the launch policies of the one or more existing workloads and evaluating the requirements of the launch policies of the one or more existing workloads are evaluated against the launch policy of the new workload.

7. The computing system of claim 1, wherein the launch policy of the new workload comprises a list of compatible workloads.

8. A method comprising:
receiving a new workload by a trusted execution environment virtual machine (TVM);
validating the new workload;
in response to the new workload being successfully validated, evaluating a launch policy of the new workload against one or more launch policies of one or more existing workloads of the TVM; and
in response to the launch policy of the new workload being successfully validated, loading the new workload into the TVM.

9. The method of claim 8, comprising launching the new workload in the TVM in response to loading the new workload into the TVM.

10. The method of claim 8, comprising generating and storing a measurement of the new workload in response to the launch policy of the new workload being successfully validated.

11. The method of claim 8, comprising rejecting the new workload in response to a security context of the TVM being finalized.

12. The method of claim 8, comprising rejecting the new workload in response to the TVM having insufficient computing resources available to run the new workload, the new workload not being validated, or the launch policy of the new workload not being successfully validated.

13. The method of claim 8, wherein evaluating the launch policy of the new workload against launch policies of one or more existing workloads of the TVM comprises evaluating requirements of the launch policy of the new workload against the launch policies of the one or more existing workloads and evaluating the requirements of the launch policies of the one or more existing workloads are evaluated against the launch policy of the new workload.

14. The method of claim 8, wherein the launch policy of the new workload comprises a list of compatible workloads.

15. At least one machine-readable storage medium comprising instructions which, when executed by at least one processor, cause the at least one processor to:
receive a new workload by a trusted execution environment virtual machine (TVM);
validate the new workload;
in response to the new workload being successfully validated, evaluate a launch policy of the new workload against one or more launch policies of one or more existing workloads of the TVM; and
in response to the launch policy of the new workload being successfully validated, load the new workload into the TVM.

16. The at least one machine-readable storage medium of claim 15, comprising instructions which, when executed by at least one processor, cause the at least one processor to launch the new workload in the TVM in response to loading the new workload into the TVM.

17. The at least one machine-readable storage medium of claim 15, comprising instructions which, when executed by at least one processor, cause the at least one processor to generate and store a measurement of the new workload in response to the launch policy of the new workload being successfully validated.

18. The at least one machine-readable storage medium of claim 15, comprising instructions which, when executed by at least one processor, cause the at least one processor to reject the new workload in response to a security context of the TVM being finalized.

19. The at least one machine-readable storage medium of claim 15, wherein evaluating the launch policy of the new workload against launch policies of one or more existing workloads of the TVM comprises instructions which, when executed by at least one processor, cause the at least one processor to evaluate requirements of the launch policy of the new workload against the launch policies of the one or more existing workloads and evaluate the requirements of the launch policies of the one or more existing workloads are evaluated against the launch policy of the new workload.

20. The at least one machine-readable storage medium of claim 15, wherein the launch policy of the new workload comprises a list of compatible workloads.
